(19) United States
(12) Patent Application Publication
(10) Pub. No.: US 2016/0378085 A1
(43) Pub. Date: Dec. 29, 2016

(54) HYBRID ENERGY STORAGE SYSTEM INCLUDING BATTERY AND ULTRA-CAPACITOR FOR A FREQUENCY REGULATION MARKET

(71) Applicant: NEC Laboratories America, Inc., Princeton, NJ (US)

(72) Inventors: Feng GUO, Sunnyvale, CA (US); Ratnesh SHARMA, Fremont, CA (US)

(21) Appl. No.: 15/189,045

(22) Filed: Jun. 22, 2016

Related U.S. Application Data
(60) Provisional application No. 62/183,264, filed on Jun. 23, 2015.

(51) Int. Cl. G05B 19/042; G06N 5/02; G06N 7/02

(52) U.S. Cl. CPC G05B 19/042; G06N 7/02; G06N 5/022; G05B 2219/2639

(57) ABSTRACT

Aspects of the present disclosure relate to methods and systems for improved hybrid energy storage systems employing batteries and ultra-capacitors (UC) operating in a frequency regulation market.

### CROSS REFERENCE TO RELATED APPLICATIONS

This application claims the benefit of U.S. Provisional Patent Application Ser. No. 62,183,264 filed Jun. 23, 2015 the entire contents of which are incorporated by reference as if set forth at length herein.

### TECHNICAL FIELD

This disclosure relates generally to energy storage methods and systems. More particularly, this disclosure relates to methods and systems for improved hybrid energy storage systems employing batteries and ultra-capacitors (UC) operating in a frequency regulation market.

### BACKGROUND

Recently, power grids have experienced a high penetration of PhotoVoltaic (PV) systems into the grids, raising concerns with respect to short-term, high-frequency fluctuations of the PV output power during unpredictable events such as weather variations. Accordingly, multiple regional system operators, such as the California Independent System Operator (CAISO), the New York Independent System Operator (NYISO), Electric Reliability Council of Texas (ERCOT), and the regional transmission organization PJM, have opened fast frequency regulation service markets. It is intended to mitigate the frequency fluctuations introduced by renewable energy generations—including PV.

As will be readily appreciated by those skilled in the art, a Battery Energy Storage System (BESS), exhibiting sufficiently fast response time(s) may advantageously participate in such markets.

Operationally—in response to frequency regulation signal(s) provided by the system operator(s), BESS operators are paid for supplying or consuming specific amount(s) of electrical power provided-to/received-from the grid(s). Unfortunately, however, the high transient nature of the frequency regulation signal expedites the degradation of the battery in this service market. Notably, the battery undergoes high-power charges and discharges, as well as a large number of cycles—oftentimes on a daily basis. Such cycling may require premature replacement of the battery before designed service time resulting in significant economic loss for the BESS operator.

Given the pervasiveness and resulting importance of BESS to energy markets, methods and structures that enhance their performance with respect to fast frequency regulation would represent a welcome addition to the art.

### SUMMARY

An advance in the art is made according to the present disclosure which describes methods and structures for improved battery energy storage systems—and in particular hybrid energy storage systems (HESS) employing batteries and ultra-capacitors (UC) operating in a frequency regulation market.

A system according to one aspect of the present disclosure—namely an improved HESS including battery and UC is described that extends the lifetime of the battery in the frequency regulation market. An intelligent power management algorithm is implemented which advantageously distributes any required power between battery(ies) and UC—while generating power command(s) for both. An advanced hardware architecture is utilized to regulate actual battery and UC output power based on a power command generated by and received from the intelligent power management algorithm.

Advantageously, and as will be shown and quantified, method(s) and structures according to the present disclosure produce significant performance improvements in HESS while reducing cost of operation. Of further advantage, illustrative intelligent power management algorithms according to the present disclosure may be selected from Fuzzy Logic, Model Predictive, Particle Swarm Optimization and Genetic Algorithm(s)—among others.

### BRIEF DESCRIPTION OF THE DRAWING

A more complete understanding of the present disclosure may be realized by reference to the accompanying drawing in which:

FIG. 1 is a schematic diagram illustrating the overall operation of methods and structures according to the present disclosure;

FIG. 2 is a schematic diagram illustrating a Hybrid Energy Storage System (HESS) operating in a serving operator frequency regulation market according to an aspect of the present disclosure;

FIG. 3 is a schematic diagram illustrating one configuration of a HESS according to an aspect of the present disclosure;

FIG. 4 is a schematic diagram illustrating a fuzzy logic controller according to an aspect of the present disclosure.

FIGS. 5(A)-5(D) are a series of schematic diagrams illustrating a number of hardware architectures according to the present disclosure in which FIG. 5(A) shows an architecture wherein one dc/dc converter and one dc/ac inverter are employed; FIG. 5(B) shows an illustrative architecture wherein two dc/dc converters and one dc/ac inverter are/is employed; FIG. 5(C) shows an illustrative architecture wherein one dc/dc converter and two dc/ac inverters is/are employed; and FIG. 5(D) shows an illustrative architecture wherein a modular multilevel converter is employed; and

FIG. 6 is a schematic block diagram showing a prior-art hardware architecture for a HESS which disadvantageously employs two DC/AC converters and a simple power management algorithm in sharp contrast to architectures and algorithms according to the present disclosure.

The illustrative embodiments are described more fully by the Figures and detailed description. Inventions according to this disclosure may, however, be embodied in various forms and are not limited to specific or illustrative embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGURES are not drawn to scale.

We begin by noting that much contemporary research has been performed with respect to improvements in battery chemistry(ies). Additionally, new materials or packing structures have been researched—all in an attempt to improve battery performance under frequent charge/discharge conditions. Unfortunately, such research and subsequent development in these areas have not adequately addressed these charge/discharge problems. More recently, developments of Hybrid Energy Storage Systems (HESS)—that combine battery(ies) and ultracapacitor(s) (UC) for frequency regulation services have been reported. (See, e.g, K. Younghyun, V. Raghunathan, and A. Raghunathan, “Design and Management of Hybrid Electrical Energy Storage Systems for Regulation Services,” International Green Computing Conference (IGCC), pp. 1-9, November 2014) Notwithstanding these approaches, relatively simple power management methods are employed to distribute power between battery and UC.

In sharp contrast—and according to one aspect of the present disclosure—an improved HESS including battery and UC is described that extends the lifetime of the battery in the frequency regulation market. An intelligent power management algorithm is implemented which advantageously distributes any required power between battery(ies) and UC—while generating power command(s) for both. An advanced hardware architecture is utilized to regulate actual battery and UC output power based on a power command generated by and received from the intelligent power management algorithm.

As will be readily appreciated by those skilled in the art, UCs are known to have a large power density and can provide instantaneous high charge and discharge power. UCs are also known to exhibit a long cycle life of over a million charge/discharge cycles at 100% depth of discharge.

Accordingly, a HESS that includes both battery and UC may advantageously provide advantages of both the battery and the UC energy sources. Utilizing intelligent power management of the battery and UC, a HESS may effectively reduce the charging and discharging cycles of the battery which may advantageously extend the working lifetime of the battery as well as the entire energy storage system.

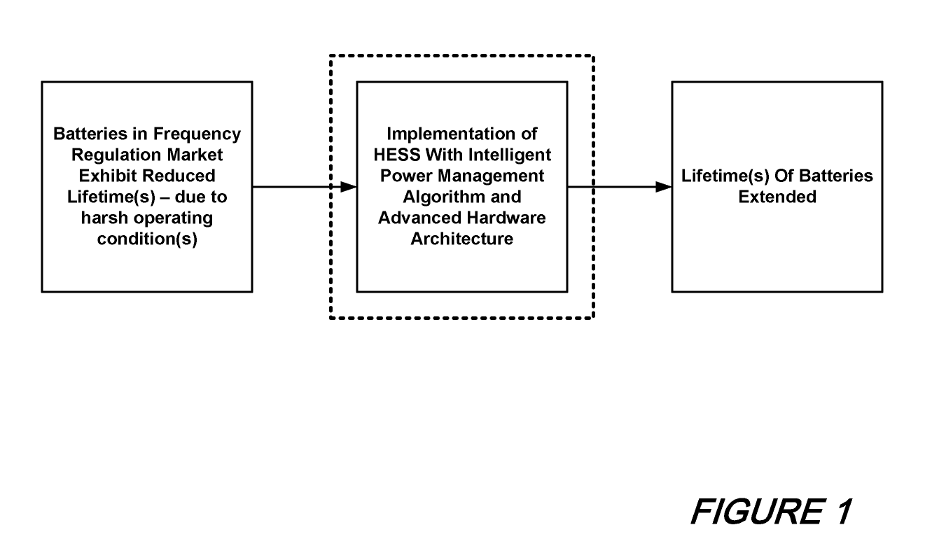

This overall value proposition of systems and methods according to the present disclosure is shown in the schematic block diagram illustrated in FIG. 1. More specifically, battery(ies) that are part of electric storage systems included in a frequency regulation market exhibit reduced lifetime(s) due—in part—to the harsh operating environment including frequent charge/discharge cycles. According to the present disclosure, implementation of HESS including intelligent power management algorithm and advanced hardware architecture(s) result in extended battery lifetime(s) and less maintenance/repair cost(s).

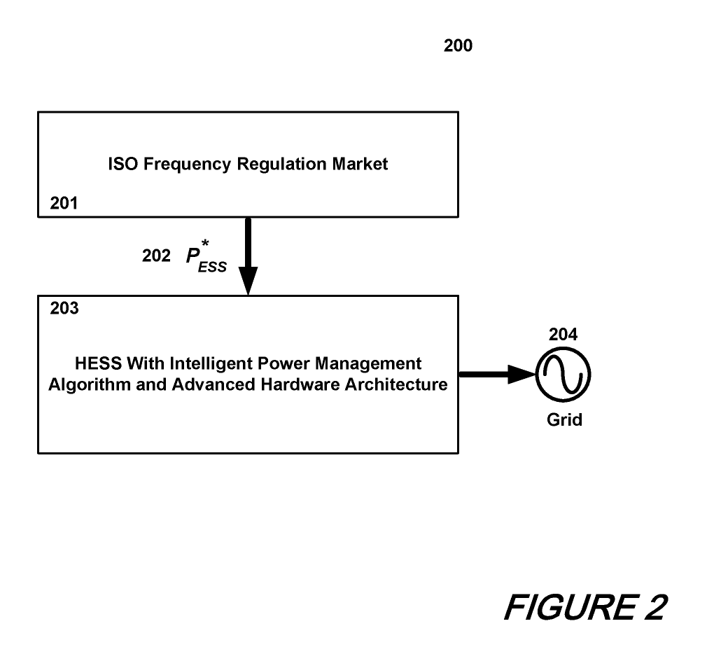

FIG. 2 is a schematic block diagram depicting an illustrative schematic configuration of a HESS operating in an ISO frequency regulation market 200. As depicted therein, frequency regulation market 201—in which the HESS operates—sends out required power output signal(s) P*_{ESS} 202 to HESS 203 at a certain frequency—for example every 4 seconds. Note that while we use the 4 second frequency for the purposes of this illustrative discussion, those skilled in the art will readily appreciate that different frequencies are contemplated and would likely vary from ISO to ISO and in particular when demands and/or generation undergoes variations. Illustratively shown further in that Figure is that HESS 203 is electrically connected to power grid 204 such that HESS 203 may provide electrical power to grid 204 as demand/generation variations dictate. As understood, HESS 203 provides any required power to grid 204 in response to signals 202 received by HESS 203 from frequency regulation market 201.

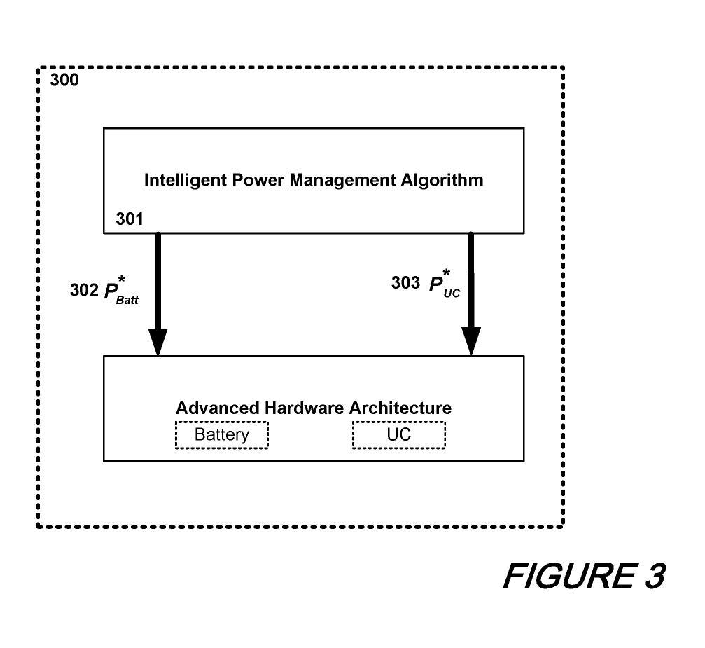

Turning now to FIG. 3 there is shown a schematic block diagram depicting an illustrative configuration 300 of a HESS according to an aspect of the present disclosure. As is depicted and may be readily understood, an intelligent power management algorithm 301 produces in the HESS 300 a distribution of any required power output between battery(ies) and UC (not specifically shown) and produces battery power command P*_{Batt} 302 and UC power command P*_{UC} 303. The relationship between required power output signal P*_{ESS}, the battery power command 302 and the UC power command 301 is shown in the following relationship:

P*_{ESS}(t)=P*_{Batt}+P*_{UC} [1]

In response, advanced hardware architecture components control the UC to output the amount of power as indicated by P*_{UC}, control the battery(ies) to output the amount of power as indicated by P*_{Batt}, and controls the HESS to output the amount of power assigned by P*_{ESS} to the grid

As may now be readily appreciated by those skilled in the art, utilizing an intelligent power management algorithm—according to the present disclosure—HESS may effectively reduce charging and discharging cycles of batteries employed with the aid of the UC—which advantageously may extend the lifetime of the entire energy storage system. Notably—and particularly advantageous—methods according to the present disclosure may utilize any of a number of different intelligent algorithms may be employed—namely, Fuzzy Logic, Model Predictive Control, Particle Swarm Optimization and Genetic Algorithm(s)—among others.

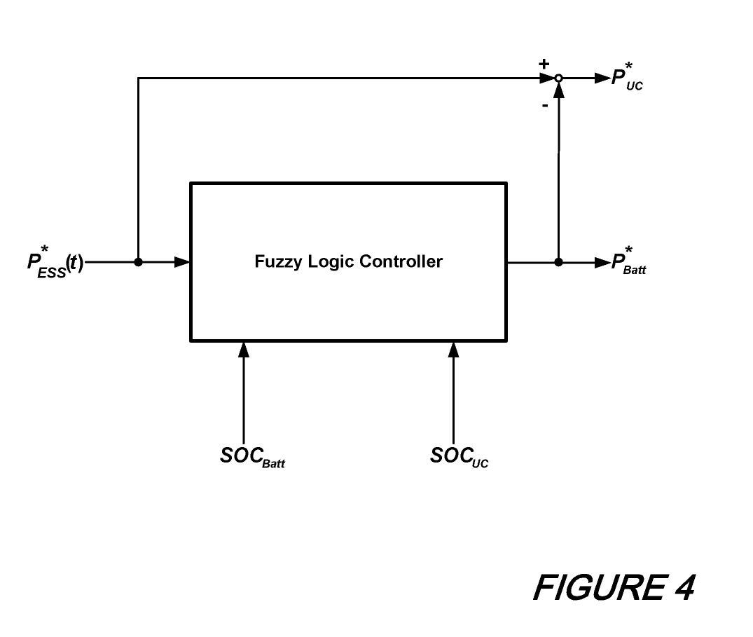

By way of illustrative example—and with reference to FIG. 4—there is shown a schematic of a fuzzy logic controller which may provide the intelligent algorithmic functions according to one aspect of the present disclosure. As may be observed from that Figure, the fuzzy logic controller receives as input(s) variables a State of Charge (SOC_{Batt}) of the battery, a State of Charge (SOC_{UC}) of the UC, and a required input P*_{ESS}(t) and produces as output a battery power command P*_{Batt}, and a UC power command, P*_{UC}. As will be appreciated, the design of such fuzzy logic controller is based on a selection of fuzzy rules, as well as the number and shape of the membership functions of each fuzzy variable.

One exemplary implementation of fuzzy rules may be described as follows:
1) The battery provides a low and smooth power supply;
2) The battery is a complementary energy source thereby regulating the UC SOC when it approaches a boundary;
3) The UC shares more power when its SOC located in a normal region thereby relieving battery from high power demand

An illustrative coding of Fuzzy Logic according to the present disclosure is shown in Appendix I.

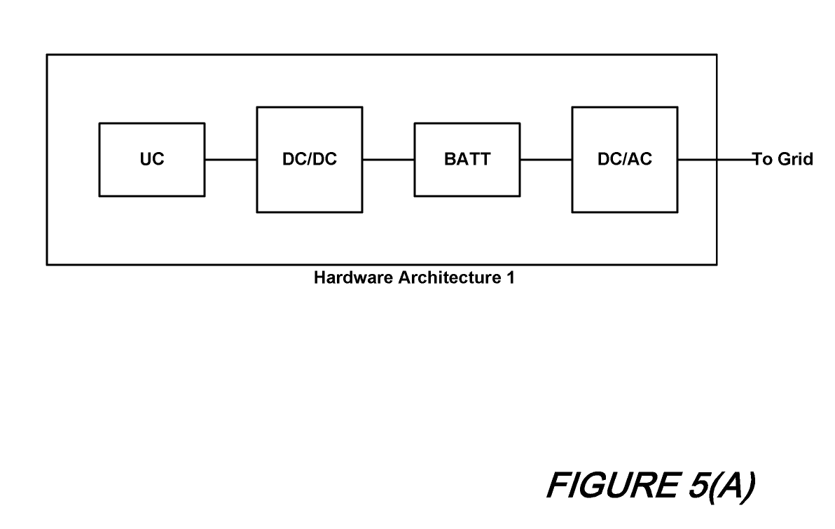

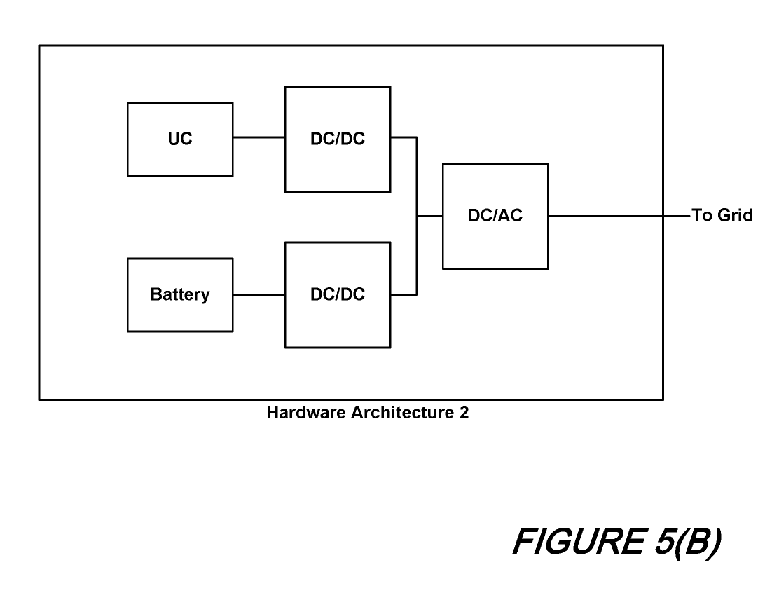

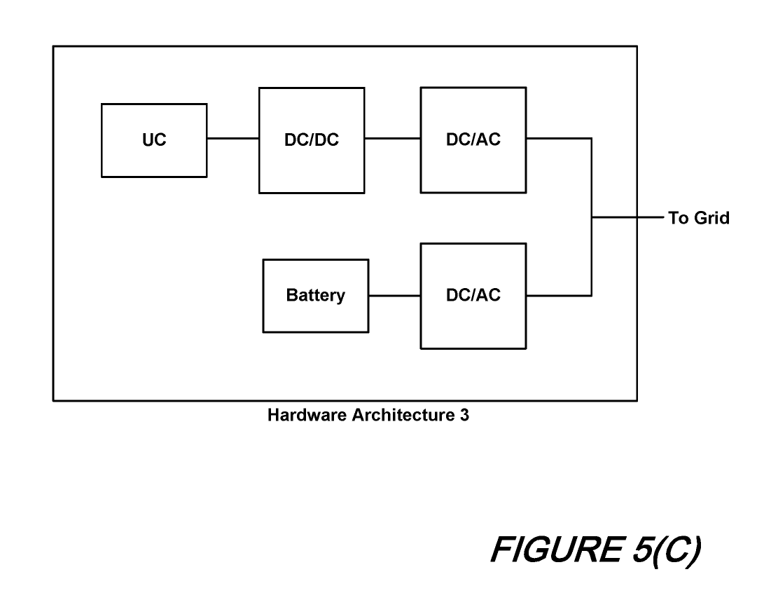

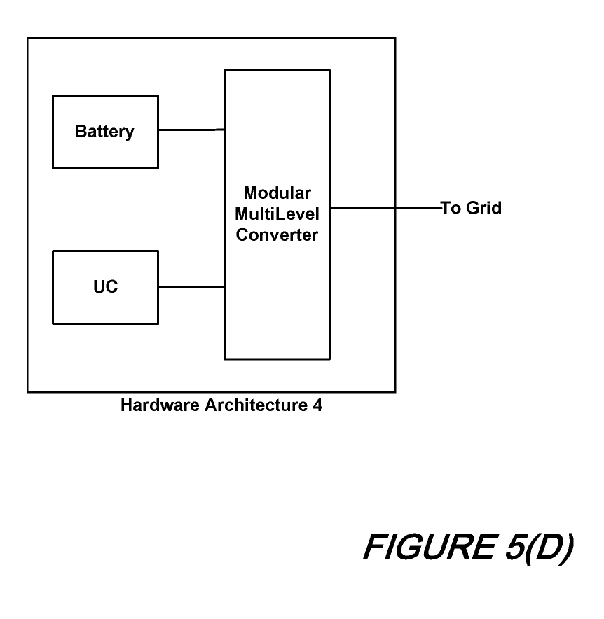

As may be further appreciated by those skilled in the art, in conjunction with intelligent algorithms, advanced hardware architecture(s)—according to the present disclosure—allow a HESS to control output power of battery(ies) and UC(s) with minimum cost and maximum flexibility. Different power electronic circuits may be selected and different architectures implemented. By way of illustrative example only—and with reference to FIG. 5(A)-FIG. 5(D), one may observe the variety of illustrative hardware architectures according to the present disclosure.

For example, FIG. 5(A) shows an illustrative architecture 1 wherein one dc/dc converter and one dc/ac inverter are employed. As may be observed from this Figure, the dc/dc converter controls the UC to output an amount of power assigned by P*_{UC} (not specifically shown in this Figure) while the dc/ac inverter controls the HESS to output an amount of power assigned by P*_{ESS}(t). The battery automatically outputs the amount of power assigned by P*_{Batt} according to the relationship shown in Equation (1).

FIG. 5(B) shows an illustrative architecture wherein two dc/dc converters and one dc/ac inverter are/is employed.

Similarly, FIG. 5(C) shows an illustrative architecture wherein one dc/dc converter and two dc/ac inverters is/are employed.

Finally, FIG. 5(D) shows an illustrative architecture wherein a modular multilevel converter is employed.

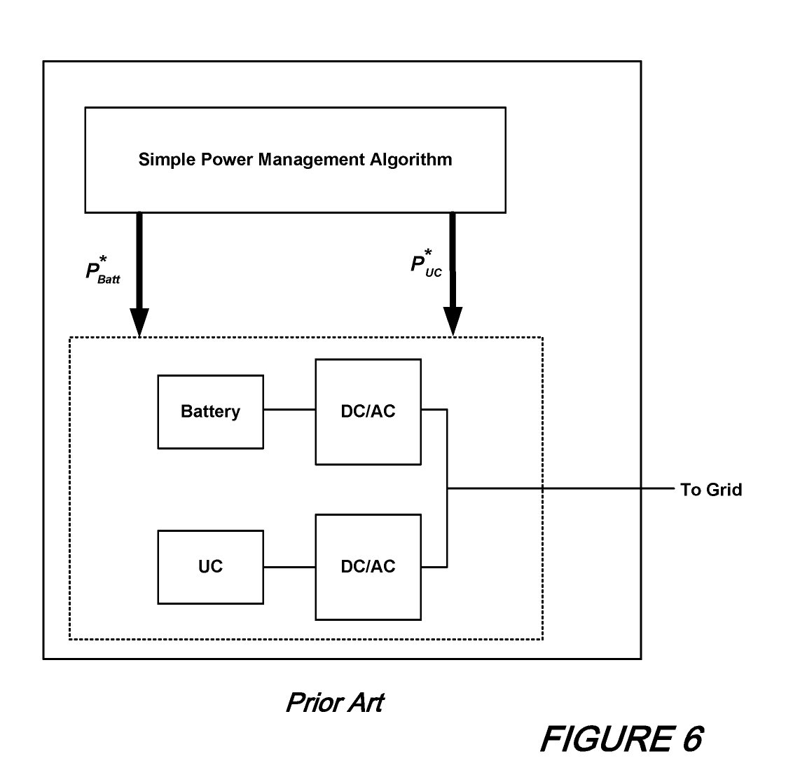

At this point it is worth noting once again that the HESS systems described in the prior art that combine batteries and ultracapacitors for frequency regulation services (e.g., K. Younghyun, V. Raghunathan, and A. Raghunathan, “Design and Management of Hybrid Electrical Energy Storage Systems for Regulation Services,” International Green Computing Conference (IGCC), pp. 1-9, November 2014) have employed—in sharp contrast to the present disclosure—relatively simple power management methods to distribute power between battery and UC. More specifically—and with reference to FIG. 6—there it shows a schematic block diagram of the system so described by the prior art. It may now be distinguished and readily appreciated by those skilled in the art that such a HESS configuration as shown by the prior art utilizes a single dc/ac inverter for a battery and another dc/ac inverter for the UC. As compared to the HESS according to the present disclosure, such a prior art configuration requires more power electronics components and is therefore more expensive to produce. Additionally, since the UC is directly connected to the dc/ac inverter, usable range of the UC is less, which results in an oversized UC and resulting higher cost as well.

By way of illustrative example only, we present Appendix 1 submitted herewith showing illustrative software code implementing our fuzzy logic algorithm as described herein. While the code is shown implemented in one particular programming language, those skilled in the art will readily appreciate that any of a number of particular programming languages and/or structures may be employed.

At this point, while we have presented this disclosure using some specific examples, those skilled in the art will recognize that our teachings are not so limited. Accordingly, this disclosure should be only limited by the scope of the claims attached hereto.

1. An improved method for operating a hybrid energy storage system (HESS) comprising a battery and an ultra-capacitor, said HESS operating in a frequency regulating market and connected to a power grid, said method comprising the steps of:
receiving at the HESS an indication of a required power output P*_{ESS}(t) transmitted from the frequency regulating market;
determining an amount of power to be contributed by the battery and an amount of power to be contributed by the ultra-capacitor to provide the required power output according to the following relationship:
P*_{ESS}(t)=P*_{Batt}+P*_{UC}
wherein P*_{Batt} is the amount of power contributed by the battery and P*_{UC} is the amount of power contributed by the ultra-capacitor.

2. The method of claim 1 wherein the determining step is performed by a controller selected from the group consisting of: a fuzzy logic controller, a model predicitive controller, a particle swarm optimization controller and a genetic controller.

3. The method of claim 1 wherein the controller is a fuzzy logic controller which receives as input(s) a required power signal P*_{ESS}(t), a State of Charge (SOC) of the battery a SOC_{Batt} signal, and a State of Charge (SOC) of the ultra-capacitor a SOC_{UC} signal and generates as output a battery power command P*_{Batt} and an ultra-capacitor power command P*_{UC} indicative of the amount of power to be contributed by the battery and ultra-capacitor respectively.

4. The method of claim 1 wherein the HESS further comprises a DC/DC converter and a DC/AC inverter, an output of the UC being connected to an input of the DC/DC converter, an output of the DC/DC converter being connected to the battery, an output of the battery being connected to an input of the DC/AC inverter, an AC output of the inverter being connected to the power grid.

5. The method of claim 1 wherein the HESS further comprises a first and second DC/DC converter and a DC/AC inverter, an output of the UC being connected to an input of the first DC/DC converter, an output of the battery being connected to an input of the second DC/DC converter, and an output of the first DC/DC converter and an output of the second DC/DC converter being connected to an input of the DC/AC inverter, an AC output of the inverter being connected to the power grid.

6. The method of claim 1 wherein the HESS further comprises a first and second DC/DAC inverter and a DC/DC converter, an output of the UC being connected to an input of the DC/DC converter, an output of the battery being connected to an input of the second DC/AC inverter, and an output of the DC/DC converter being connected to an input of the first DC/AC inverter, the outputs of the first and second DC/AC inverters being connected together and the combined AC output of the inverters being connected to the power grid.

7. The method of claim 1 wherein the HESS further comprises a modular multilevel converter having at least two DC inputs and an AC output, an output of the UC being connected to the first input of the modular multilevel converter, an output of the battery being connected to the second input of the modular multilevel converter, the AC output of the modular multilevel converter being connected to the power grid.

8. A hybrid energy storage system (HESS), said HESS operating in a frequency regulating market and connected to a power grid, said HESS comprising:
an advanced power management controller running an intelligent power management algorithm;
an advanced hardware architecture including a battery and an ultra-capacitor;
wherein in response to receiving an indication of a required power output P*_{ESS}(t) transmitted from the frequency regulating market, the power management controller determines an amount of power to be contributed by the battery and an amount of power to be contributed by the ultra-capacitor to provide the required power output according to the following relationship:
P*_{ESS}(t)=P*_{Batt}+P*_{UC}
wherein P*_{Batt} is the amount of power contributed by the battery and P*_{UC} is the amount of power contributed by the ultra-capacitor.

9. The HESS of claim 8 wherein said intelligent controller is one selected from the group consisting of: a fuzzy logic controller, a model predicitive controller, a particle swarm optimization controller and a genetic controller.

10. The HESS of claim 8 wherein the intelligent controller is a fuzzy logic controller which receives as input(s) the required power signal P*_{ESS}(t), a State of Charge (SOC) of the battery a SOC_{Batt} signal, and a State of Charge (SOC) of the ultra-capacitor a SOC_{UC} signal and generates as output a battery power command P*_{Batt} and an ultra-capacitor power command P*_{UC} indicative of the amount of power to be contributed by the battery and ultra-capacitor respectively.

11. The HESS of claim 8 further comprising a DC/DC converter and a DC/AC inverter, an output of the UC being connected to an input of the DC/DC converter, an output of the DC/DC converter being connected to the battery, an output of the battery being connected to an input of the DC/AC inverter, an AC output of the inverter being connected to the power grid.

12. The HESS of claim 8 further comprising a first and second DC/DC converter and a DC/AC inverter, an output of the UC being connected to an input of the first DC/DC converter, an output of the battery being connected to an input of the second DC/DC converter, and an output of the first DC/DC converter and an output of the second DC/DC converter being connected to an input of the DC/AC inverter, an AC output of the inverter being connected to the power grid.

13. The HESS of claim 8 further comprising a first and second DC/DAC inverter and a DC/DC converter, an output of the UC being connected to an input of the DC/DC converter, an output of the battery being connected to an input of the second DC/AC inverter, and an output of the DC/DC converter being connected to an input of the first DC/AC inverter, the outputs of the first and second DC/AC inverters being connected together and the combined AC output of the inverters being connected to the power grid.

14. The HESS of claim 1 further comprising a modular multilevel converter having at least two DC inputs and an AC output, an output of the UC being connected to the first input of the modular multilevel converter, an output of the battery being connected to the second input of the modular multilevel converter, the AC output of the modular multilevel converter being connected to the power grid.
